(19) United States
(12) Patent Application Publication
(10) Pub. No.: US 2015/0146099 A1
(43) Pub. Date: May 28, 2015

(54) IN-LINE SIGNAL PROCESSOR

(71) Applicants: Anthony Bongiovi, Port St. Lucie, FL (US); Glenn Zelniker, Gainesville, FL (US); Joseph Butera, III, Stuart, FL (US); Phillip Fuller, New York, NY (US); Qiu Xihong, Guangzhou (CN)

(72) Inventors: Anthony Bongiovi, Port St. Lucie, FL (US); Glenn Zelniker, Gainesville, FL (US); Joseph Butera, III, Stuart, FL (US); Phillip Fuller, New York, NY (US); Qiu Xihong, Guangzhou (CN)

(21) Appl. No.: 14/153,390

(22) Filed: Jan. 13, 2014

Related U.S. Application Data
(60) Provisional application No. 61/908,402, filed on Nov. 25, 2013.

(51) Int. Cl. H04R 3/00

(52) U.S. Cl. CPC H04R 3/00
USPC 348/500; 381/98

(57) ABSTRACT

The present invention provides for a cable which enhances an audio signal between two devices, such as an mp3 player and a speaker system, or a set-top box and home theater system. The cable includes integrated hardware and software elements for processing the signal. In various embodiments the cable may also include a user interface and selectable profiles which adjust the processing scheme for various purposes, such as a profile for environments with high ambient noise, or profiles for certain styles of music.

### CLAIM OF PRIORITY

The present application is based on and a claim of priority is made under 35 U.S.C. Section 119(e) to a provisional patent application that is currently pending in the U.S. Patent and Trademark Office, namely, that having Ser. No. 61/908,402 and a filing date of Nov. 25, 2013, and which is incorporated herein by reference.

### FIELD OF THE INVENTION

The invention provides a device for processing digital signals, particularly audio signals. Specifically, the invention relates to cables that contain both hardware and software configured to enhance audio signals between two devices.

### DESCRIPTION OF THE RELATED ART

Historically, studio-quality sound, which can best be described as the full reproduction of the complete range of audio frequencies that are utilized during the studio recording process, has only been achievable, appropriately, in audio recording studios. Studio-quality sound is characterized by the level of clarity and brightness which is attained only when the upper-mid frequency ranges are effectively manipulated and reproduced. While the technical underpinnings of studio-quality sound can be fully appreciated only by experienced record producers, the average listener can easily hear the difference that studio-quality sound makes.

While various attempts have been made to reproduce studio-quality sound outside of the recording studio, those attempts generally come at tremendous expense usually resulting from costly hardware and software necessary to digitally process the audio signals. Furthermore the necessary hardware is usually bulky or heavy, and not well suited to use as a portable device. Thus there exists a need for an in-line signal processor, providing both the required software and hardware, which enhances audio signals between a consumer device, such as an mp3 player, smart phone, or DVD player, and an output device, such as a television, amplified speaker, or home audio system.

Accordingly, there are devices which may be seen as structurally similar to the present invention, but are not directed towards solving the problems presented with attaining studio quality sound with an in-line signal processor. For example, expired U.S. Pat. No. 4,532,796 to Martens et. al. discloses a dual transducer connection utilizing a single cable 50. The system includes a transmitter 42 and receiver 44 coupled in-line to a signal processor 46 for the generation of an electrical signal which is applied to the transmitter. The invention disclosed by Martens et. al. is directed towards generating a digital signal for diagnostic purposes. The present invention, on the other hand receives a signal from an external device and then enhances desired characteristics of that signal, before transmitting the enhanced signal to a second external device.

### SUMMARY OF THE INVENTION

The present invention meets the existing needs described above with a device providing audio enhancement between two externally connected devices, such as an mp3 player and a speaker. The invention can be broadly described as a cable, with connectors on each end and a housing along its length. The housing contains hardware and software elements configured to manipulate an input signal, thereby creating an output signal with one or more characteristics enhanced relative to the input signal.

More specifically, the invention comprises input and output connectors, which can be of any of a plurality of standard or non-standard connectors, e.g. component, composite, USB, HDMI, 3.5 mm, etc. The input connector transmits an input signal to a processor module via a first cable segment. The processor module may comprise any combination of the necessary hardware and/or software necessary to modulate or adjust one or more of the desired characteristics of the signal. During this process, the input signal is transformed into an output signal. The output signal is then transmitted to the output connector via a second cable segment.

Other embodiments of the invention may also include user-selectable profiles, which adjust the parameters associated with manipulation of the input signal according to a user's desire. Accordingly, embodiments which include profile modules may also include one or more user interfaces which facilitate selection of user-selectable profiles and also addition, deletion, or adjustment of the profiles themselves.

Other embodiments of the invention include further modules and structuring necessary to accommodate an input signal that is comprised of a combined audio and video signal. More specifically, in this embodiment, the invention includes one or more extra modules which are capable of separating the combined signal into its component audio and video signals, delay the video signal while the audio signal is processed, and then recombine the component audio and video signals into an output signal. Accordingly, the input and output connectors as well as the first and second cable segments include the necessary structure to transmit the combined signal.

Further still the invention may be capable of drawing electrical power from the external devices it is connected to. As a non-limiting example, in one embodiment the input connector comprises a USB connector. The input connector is then capable of being connected to a personal computer to receive audio signals. In this embodiment, the invention also draws electrical current from the personal computer in order to power the processing module. In yet other embodiments, the invention may include a battery compartment for powering the processing module.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of a communications cable for processing an input signal according to one embodiment of the invention.

FIG. 2 is a schematic depicting the process of creating an output signal from an input signal according to one embodiment of the invention.

FIG. 3 is a schematic depicting the process of creating an output signal from an input signal according to one embodiment of the invention.

FIG. 4 is a schematic depicting a predetermined processing scheme according to one embodiment of the invention.

Like reference numerals refer to like parts throughout the several views of the drawings.

### DETAILED DESCRIPTION OF THE PREFERRED EMBODIMENT

The invention comprises a first cable segment 11 suitable for the transmission of signals. For example the first cable segment 11 may be of a standard cable type, including one or more wires such as copper wires that are bundled together and surrounded by an insulating material such as rubber or plastic. The first cable segment 11 may also include optical fibers, as well as any other medium appropriate for the communication of signals and/or data.

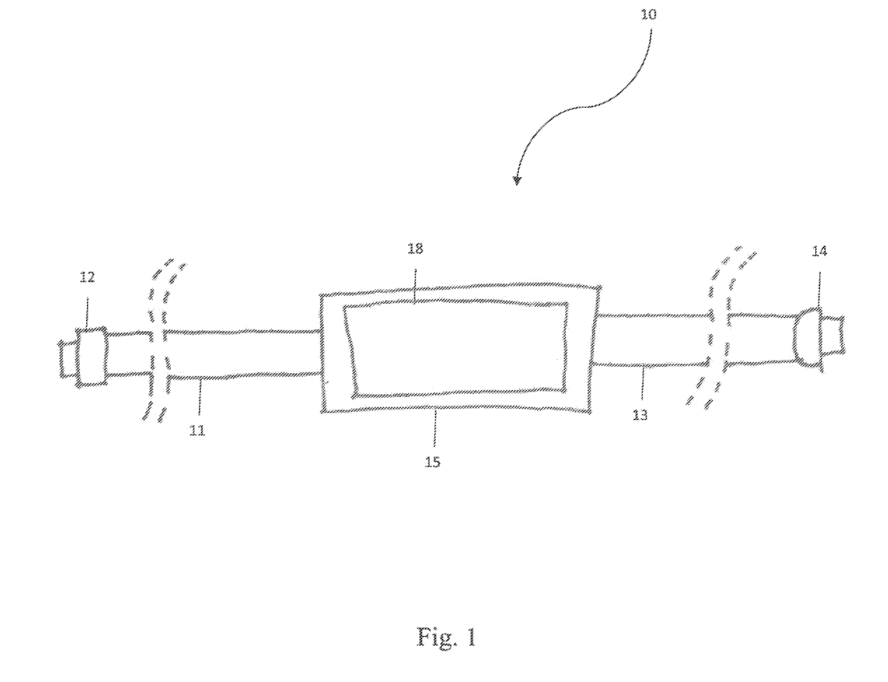

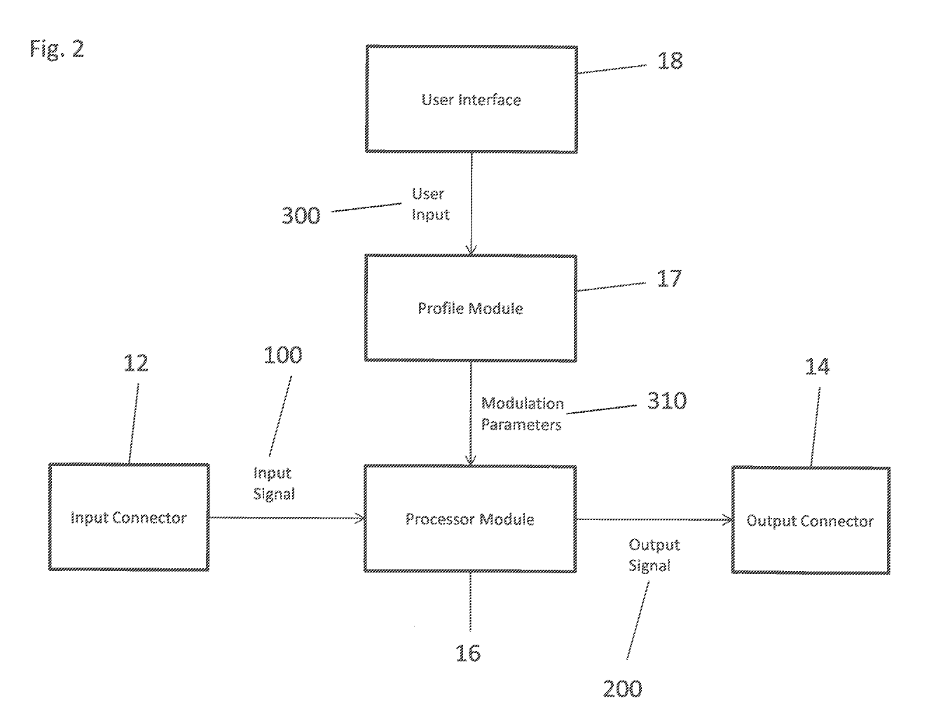

With reference to FIGS. 1 and 2, an input connector 12 is attached to the first cable segment 11. In the preferred embodiment, the input connector 12 can be of a variety of any standard types including, but not limited to, component, composite, coaxial, 3.5 mm phone connector, universal serial bus, optical, high definition multimedia WiFi, or Bluetooth. The input connector 12 receives an input signal 100 from an input device, such as an mp3 player, and transmits the input signal 100 to the processor module 16 via the first cable segment 11.

The processor module 16 is contained by a housing 15. In the preferred embodiment, the housing 15 is structured from rubber, plastic, or metal, or other suitably durable material, and is situated between the first cable segment 11 and the second cable segment 13. The housing 15 is further structured to securely contain the processor module 16 and other modules as necessary, and also to protect the elements contained therein from damage from such things as impacts, moisture, debris, etc. In at least one other embodiment, the housing 15 may extend between the input and output connectors forming a relatively thick cable (not depicted).

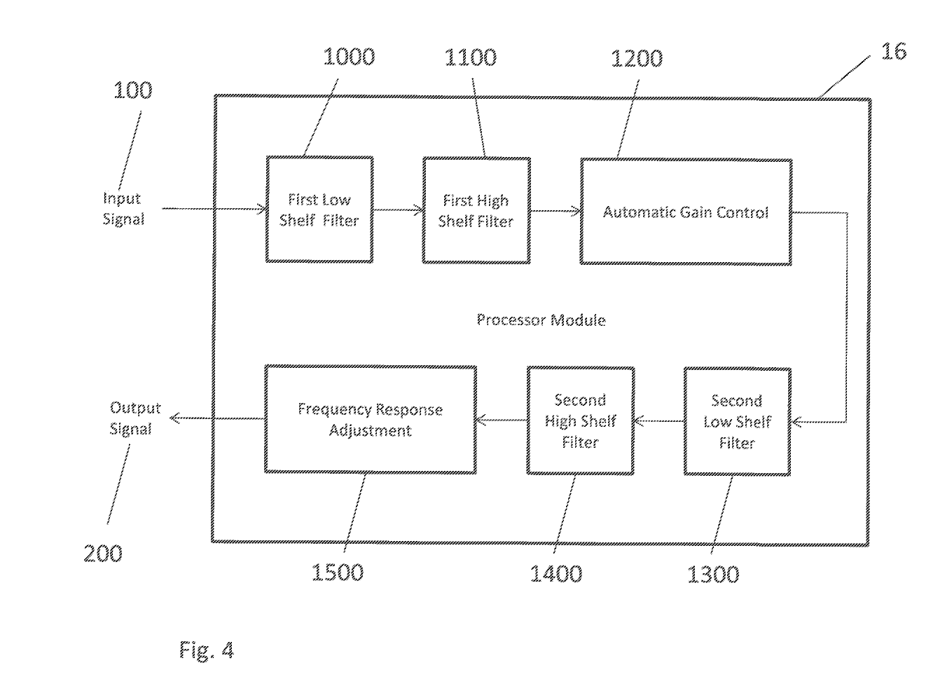

The processor module 16 contains the necessary hardware and/or software to modulate one or more characteristics of the input signal 100 according to a predetermined processing scheme, resulting in an output signal 200 with one or more characteristics enhanced relative to the input signal 100. As a non-limiting example, the processor module 16 may be configured to modulate the input signal 100 according to the following scheme, as depicted in FIG. 4:

First, the input signal 100 is processed with a first low shelf filter 1000 and a first high shelf filter 1100 having predetermined center frequency values and gain values, thereby creating a differential between the high and low frequencies of the signal. In the preferred embodiment, this differential is on the order of 24 dB. Then the gain of the signal is modulated utilizing an automatic gain control 1200 such as a compressor or limiter. Then the signal is processed by a second low shelf filter 1300 and a second high shelf filter 1400, the center frequency values of which are the same as the first set of filters, 1000 and 1100. However, the gain values of the second set of filters, 1300 and 1400, are inversed relative to the first set of filters, 1000 and 1100. Then the signal may be processed by any method of frequency response adjustment 1500 such as predetermined equalization bands and/or frequency-range specific gain control elements to further fine tune and create the output signal 200.

It is also envisioned that the predetermined processing scheme, such as the one described above, will be performed after receiving an input signal 100 from an audio source and transmit the output signal 200 to a signal amplifier or other output source such as a speaker, which is not part of the present invention.

Once the processor module 16 performs the predetermined processing scheme with the input signal 100, thereby creating the output signal 200, the output signal 200 is then transmitted to an output connector 14 via a second cable segment 13. The second cable segment 13 is generally identical to, but in some embodiments may be somewhat different than, the first cable segment 11 as described above. In some embodiments, either the first cable segment 11 or the second cable segment 13 may be utilized to transmit electrical power to at least the processor module 16 and accordingly either cable will include such structure as is necessary. The output connector 14 is substantially similar to the input connector 12 as disclosed above. It may be of the same type of connector as the input connector 12 or it may be of a different type, depending on the user's need. Just as the input connector 12 is configured to connect to an input device, such as an mp3 player, the output connector 14 is configured to connect to an output device such as an amplifier or a speaker.

As disclosed above, either the first cable segment 11 or the second cable segment 13 may be configured to transmit electrical power to at least the processor module from a connected external device. In some scenarios, this mode may not always be feasible. Accordingly, in some embodiments the housing 15 may also accommodate an integral power source (not depicted), such as by a battery compartment. Alternatively, the housing may also include a receptacle for an external power source such as an AC/DC adapter connected to a wall outlet.

In at least one embodiment, the invention also includes a profile module 17. The profile module 17 may be integral with the processor module 16. The profile module 17 may also be contained along with the processor module 16 in the housing 15. The profile module 17 includes a medium for storing a plurality of process profiles which modulate or adjust various parameters of the processing scheme associated with the processor module. As a non-limiting example, the profile module may change the center frequency values and/or the gain values of the first, 1000 and 1100, or second, 1300 and 1400, set of filters in the processing scheme described above in order to produce an output signal 200 with certain desired characteristics. It will be appreciated that the profile module 17 must be in communication with the processor module 16 in order to modulate or adjust the parameters of the processing scheme.

In yet another embodiment, the invention may also include a user interface 18 which is configured to allow a user to at least select any one of a plurality of predetermined, user-selectable profiles. The user interface may comprise any combination of displays, buttons, and/or touch screens disposed on the housing 15. The user interface may display relevant information pertaining the process profiles, as well as allow a user to interact with the profile module in order to select one of the predetermined, user-selectable profiles. For example, a display portion of a user interface 18 may enable a user to visually perceive one of a plurality of process profiles that is directed to a particular model of speaker or headphone. Other possibilities may include profiles directed to listening environments, such as those with high ambient noise, or with a high echo. Also, there may be separate audio profiles for signals associated with voices; different types of music such as rock, jazz, or hip-hop; or different types of televised content such as movies or television shows. The profiles may be previously stored on the invention, retrieved from firmware, or downloaded from a network.

It will be appreciated by those skilled in the art that, in at least one embodiment, the user interface 18 may be in communication with the profile module 17 in order to communicate user input 300 to the profile module 17. Furthermore, the profile module 17 may be in communication with the processor module 16 in order to communicate any of a plurality of modulation parameters 310 that a user wishes to adjust via the user input 300 communicated to the profile module 16 from the user interface 18.

By way of another example, the user-interface 18 may also comprise software or other graphical user interface designed to be operated on an external computer to which the present invention may be connected. In such an embodiment, it is envisioned that at least the input connector 12 will be of the universal serial bus type to facilitate efficient configuration of the profile module 17. It is also envisioned that the invention may draw power through the universal serial bus input connector 12. In other embodiments, the profile module may be configured via wireless connection(s), such as Bluetooth, WiFi, Apple Airplay, infrared, RF, near-field communication, and/or other appropriate wireless technologies as known to those skilled in the art.

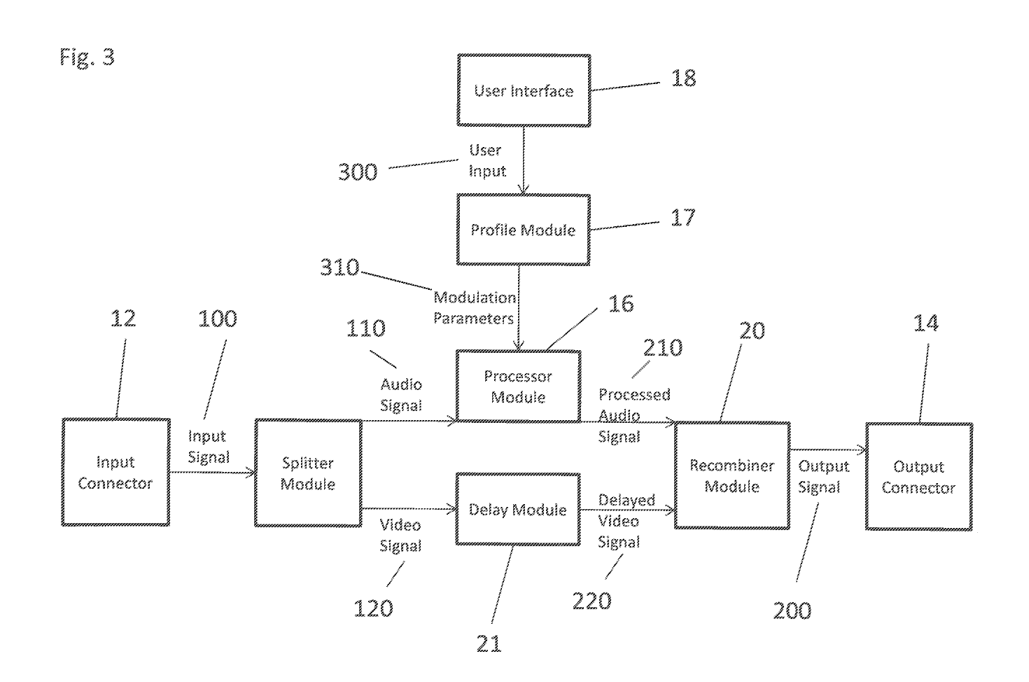

In a final embodiment, and with reference to FIG. 3, at least the input connector 12, but also the output connector 14 may be configured to communicate, respectively, an input signal 100 and output signal 200 comprising a combined audio signal 110 and video signal 120. In this embodiment, the first cable segment 11 and second cable segment 13 are accordingly configured to transmit the combined audio signal 110 and video signal 120. Also in this embodiment, the audio enhancing cable 10 further includes a splitter module 19, configured to receive the input signal 100 and separate it into an audio signal 110 and a video signal 120. The audio signal 110 is transmitted to the processor module 16 where the predetermined processing scheme is performed, thereby creating a processed audio signal 210. The splitter module also transmits the video signal 120 to a delay module 21, where the video signal 120 is delayed relative to the amount of time necessary to complete a processing scheme. The delay module 21 then transmits the delayed video signal 220 to a recombiner module 20, whereby the processed audio signal 210 and delayed video signal 220 are recombined into an output signal 200. The recombiner module 20 then transmits the output signal 200 to the output connector 14. It can be appreciated that the splitter module 19, delay module 21, and recombiner module 20, may be integral with the processor module, or separated, or any combination thereof. It is also envisioned that the splitter module 19, delay module 21, and recombiner module 20 may be contained in the housing 15.

Those skilled in the art will appreciate that more or less modules may perform the functions of the modules described herein, such as the processor module 16, profile module 17, etc. Modules may comprise any form of hardware, software, or a combination of both. Hardware modules may comprise any form of hardware including circuitry. Software modules may comprise instructions that may be stored within a computer readable medium such as a RAM, ROM, flash memory, and the like. The instructions of the software may be executable by a processor to perform the functions described herein.

Those skilled in the art may also appreciate that the present invention may be constructed or assembled in a variety of different ways, such as by removably connecting various subassemblies. For example a first subassembly may comprise the input connector 12 and first cable segment 11; a second subassembly may comprise the housing 15 and at least a processor module 16; and a third subassembly may comprise the output connector 14 and second cable segment 13. In the preferred embodiment, however, the input connector 12, first cable segment 11, housing 15, second cable segment 13, and output connector 14, are all integrally molded.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

1. A communications cable for processing an input signal comprising:
an input connector, said input connector operatively structured to receive an input signal;
a processor module, said processor module configured to receive and process said input signal according to a predetermined processing scheme, thereby creating an output signal;
said predetermined processing scheme operative to enhance at least one characteristic of said input signal through at least one filter;
said output signal at least partially defined by at least one characteristic enhanced relative to said input signal;
a first cable segment, said first cable segment accomplishing wired communication of said input signal from said input connector to said processor module;
an output connector, said output connector operatively structured to transmit an output signal;
a second cable segment, said second cable segment accomplishing wired communication of said output signal from said processor module to said output connector;

2. The cable as recited in claim 1 further comprising a profile module; said profile module in communication with said processor module; and said profile module comprising a medium for storing a plurality of process profiles which modulate the parameters of said processor module including frequency adjustment of the at least one filter.

3. The cable as recited in claim 2 further comprising a user interface; said user interface in communication with said profile module; and said user interface operatively structured to allow a user to select any one of said plurality of process profiles.

4. The cable as recited in claim 3 wherein said user interface is further structured and configured to allow a user to modify any of said plurality of process profiles.

5. The cable as recited in claim 3 wherein said profile module is contained in said housing.

6. The cable as recited in claim 3 wherein said user interface is contained in said housing.

7. The cable as recited in claim 1 further comprising a splitter module, said splitter module in wired communication between said input connector and said processor module, and said splitter module configured to separate a combined audio and video signal.

8. The cable as recited in claim 7 further comprising a delay module; said delay module in wired communication with at least said splitter module; and said delay module configured to receive said video signal and pause a predetermined period of time before transmitting said video signal.

9. The cable as recited in claim 9 further comprising a recombiner module; said recombiner module in communication between said processor module, said delay module, and said output connector; and said recombiner module configured to receive said delayed video signal and a processed audio signal, and combine both, thereby creating an output signal.

10. The cable as recited in claim 1 wherein said input connector is removably connected to said processor module.

11. The cable as recited in claim 1 wherein said output connector is removably connected to said processor module.

12. The cable as recited in claim 1 wherein said input connector comprises a universal serial bus connector.

13. The cable as recited in claim 1 wherein said output connector comprises a universal serial bus connector.

14. The cable as recited in claim 1 wherein said input connector comprises a high definition multimedia interface connector.

15. The cable as recited in claim 1 wherein said output connector comprises a high definition multimedia interface connector.

16. The cable as recited in claim 1 wherein said input connector transmits electrical power to said processor module from a connected device.

17. The cable as recited in claim 1 wherein said output connector transmits electrical power to said processor module from a connected device.

18. The cable as recited in claim 1 further comprising an integral electrical power source; said integral electrical power source contained in said housing; and said integral electrical power source operatively structured to transmit electrical power to said processor module.

19. The cable as recited in claim 1 further comprising a plurality of input connectors in wired communication with said processor module.

20. The cable as recited in claim 1 further comprising a plurality of output connectors in wired communication with said processor module.

21. A communications cable for processing an input signal comprising:
an input connector, said input connector operatively structured to receive an input signal;
a processor module, said processor module configured to receive and process said input signal according to a predetermined processing scheme, thereby creating an output signal;
said predetermined processing scheme operative to filter at least one frequency value of said input signal through at least one filter in order to create said output signal;
a profile module, said profile module in communication with said processor module; and said profile module comprising a medium for storing a plurality of process profiles which modulate the parameters of said processor module;
a first cable segment, said first cable segment accomplishing wired communication of said input signal from said input connector to said processor module;
an output connector, said output connector operatively structured to transmit an output signal;
a second cable segment, said second cable segment accomplishing wired communication of said output signal from said processor module to said output connector;
a housing, said housing containing at least said processor module;
said input connector, said first cable segment, said housing, said second cable segment, and said output connector, all being integrally molded.

22. The cable as recited in claim 21 further comprising a user interface; said user interface in communication with said profile module; and said user interface operatively structured to allow a user to select any one of said plurality of process profiles.

23. The cable as recited in claim 22 wherein said user interface is further structured and configured to allow a user to modify any of said plurality of process profiles.

24. The cable as recited in claim 22 wherein said profile module is contained in said housing.

25. The cable as recited in claim 22 wherein said user interface is disposed on said housing.

26. The cable as recited in claim 21 further comprising a splitter module, said splitter module in wired communication between said input connector and said processor module, and said splitter module configured to separate a combined audio and video signal.

27. The cable as recited in claim 26 further comprising a delay module; said delay module in wired communication with at least said splitter module; and said delay module configured to receive said video signal and pause a predetermined period of time before transmitting said video signal.

28. The cable as recited in claim 27 further comprising a recombiner module; said recombiner module in communication between said processor module, said delay module, and said output connector; and said recombiner module configured to receive said delayed video signal and a processed audio signal, and combine both, thereby creating an output signal.

29. The cable as recited in claim 28 wherein said splitter module is contained in said housing.

30. The cable as recited in claim 28 wherein said delay module is contained in said housing.

31. The cable as recited in claim 28 wherein said recombiner module is contained in said housing.

32. The cable as recited in claim 21 wherein said profile module comprises a process profile for frequency adjustment of said at least one filter.

33. The cable as recited in claim 21 wherein said predetermined processing scheme is further operative to modulate the gain of the input signal through at least one gain control in order to create said output signal.

34. The cable as recited in claim 33 wherein said profile module comprises a process profile for gain adjustment of said at least one gain control.
